(19) United States
(12) Patent Application Publication
(10) Pub. No.: US 2023/0344260 A1
(43) Pub. Date: Oct. 26, 2023

(54) BATTERY CHARGING METHOD, ELECTRIC DEVICE, AND STORAGE MEDIUM

(71) Applicant: NINGDE AMPEREX TECHNOLOGY LIMITED, Ningde City (CN)

(72) Inventor: Ao Liu, Ningde City (CN)

(73) Assignee: NINGDE AMPEREX TECHNOLOGY LIMITED, Ningde City (CN)

(21) Appl. No.: 18/342,931

(22) Filed: Jun. 28, 2023

Related U.S. Application Data
(63) Continuation of application No. PCT/CN2021/082844, filed on Mar. 24, 2021.

(51) Int. Cl. H02J 7/00; H01M 10/46; H01M 10/44

(52) U.S. Cl. CPC H02J 7/00714; H02J 7/007182; H01M 10/46; H01M 10/443

(57) ABSTRACT

A battery charging method, including: charging a battery in a charging manner under a first ambient temperature T1 until a voltage of the battery reaches first cutoff voltage U1 and/or a current of the battery reaches a first cutoff current I1, so that a first charge capacity of the battery is Q1; and charging the battery in the charging manner under a second ambient temperature T2 until the voltage of the battery reaches a second cutoff voltage U2 and/or the current of the battery reaches a second cutoff current I2, so that a second charge capacity of the battery is, where T2>T1, U2<U1, I1<I2, and Q1=Q2. This application can improve performance of the battery under a high temperature.

### CROSS-REFERENCE TO RELATED APPLICATIONS

This application is a continuation application of International Application No. PCT/CN20211082844, filed on Mar. 24, 2021, the contents of which are incorporated herein by reference in its entirety.

### TECHNICAL FIELD

This application relates to the technical field of batteries, and in particular, to a battery charging method, an electric device, and a storage medium.

### BACKGROUND

The currently prevalent battery charging method is constant-current charging plus constant-voltage charging. That is, the battery is charged at a constant current until a specified voltage, and then charged at a constant voltage. A reason for adopting such a charging method is that polarization occurs in the battery during the charging. The higher the charge current, the more obvious the polarization of the battery. When the battery is charged at a constant current until the voltage reaches a specified value, cells of the battery are not fully charged due to the polarization. Therefore, the battery needs to be further charged at a constant voltage. Under actual working conditions, factors that affect the polarization of the battery include not only the current, but also the ambient temperature. The higher the ambient temperature, the weaker the polarization of the battery. When the above charging method is adopted, the polarization of the battery is weakened to some extent when the battery is charged at a constant current until a high temperature. However, in the process of constant-voltage charging, the potential of the positive electrode of the battery is somewhat higher than that of the battery charged under a normal temperature. Therefore, in the period of constant-voltage charging, the charge capacity of the battery is higher than the charge capacity in the period in which the battery is charged under a normal temperature, and the battery is overcharged to some extent, thereby deteriorating the degree of delithiation of the negative electrode and deteriorating the high-temperature performance of the battery.

### SUMMARY

In view of the situation described above, it is necessary to provide a battery charging method, an electric device, and a storage medium to improve performance of a battery under a high temperature.

An embodiment of this application provides a battery charging method. The method includes: charging a battery in a charging manner under a first ambient temperature T1 until a voltage of the battery reaches a first cutoff voltage U1 and/or a current of the battery reaches a first cutoff current I1, so that a first charge capacity of the battery is Q1; and charging the battery in the charging manner under a second ambient temperature T2 until the voltage of the battery reaches a second cutoff voltage U2 and/or the current of the battery reaches a second cutoff current I2, so that a second charge capacity of the battery is Q2, where T2>T1. U2<U1, I1<I2, and Q1=Q2.

According to some embodiments this application, T1<35 CC, and 35° C.<T2<60 CC.

According to some embodiments this application, the second cutoff voltage U2 is greater than or equal to a reduction potential of an electrolytic solution of the battery.

According to some embodiments this application, U_{c1}—500 mV<U2<U_{c1} where U_{c1} is a limited charge voltage of the battery. The limited charge voltage may be understood as a system upper-limit voltage of the battery.

According to some embodiments this application, I1<12<I1+0.2 C.

According to some embodiments this application, the first charge capacity is a full charge capacity of the battery under T1.

According to some embodiments this application, the charging, manner includes a first charging manner. The first charging manner includes N sequential charging sub-stages, where N is an integer greater than or equal to 2. The N charging sub-stages are defined as an r charging sub-stage, where i=1, 2, 3, . . . , N, respectively. In the charging sub-stage, the battery is charged at an i^{th} current or an it voltage or an i^{th} power. In an (i+1)^{th} charging sub-stage, the battery is charged at an (i+1)^{th} current or an (i+1)^{th} voltage or an (i+1)^{th} power. A charge current of the battery in the (i+1)th charging sub-stage is less than or equal to a charge current in the charging sub-stage.

According to some embodiments this application, the (i+1)^{th} voltage is greater than or equal to the voltage, and the (i+1)^{th} power is less than or equal to the power.

According to some embodiments this application, the second cutoff current I2 is less than or equal to a current of the battery at time of completing the i^{th} charging sub-stage.

According to some embodiments this application, the charging manner includes a second charging manner. The second charging manner includes M sequential charging sub-stages, where M is an integer greater than or equal to 2. The M charging sub-stages are defined as a j^{th} charging sub-stage, where j=1, M, respectively. Each j^{th} charging sub-stage includes a j^{th} earlier charging sub-stage and a j′h later charging sub-stage. In one of the j^{th} earlier charging sub-stage or the j^{th} later charging sub-stage, the battery is not charged or is charged or discharged at a j^{th} earlier charge sub-current for a duration of Tj1. In the other of the j^{th} earlier charging sub-stage or the j^{th} later charging sub-stage, the battery is charged at a j^{th} later charge sub-current for a duration of Tj2. An absolute value of the j^{th} earlier charge sub-current is smaller than an absolute value of the j^{th} later charge sub-current.

According to some embodiments this application, an average value of a charge current in the (j+1)^{th} charging sub-stage is less than or equal to a charge current in the j^{th} sub-stage.

According to some embodiments this application, the second cutoff current I2 is less than or equal to a current of the battery at time of completing the i^{th} charging sub-stage.

An embodiment of this application provides an electric device. The electric device includes: a battery; and a processor. The processor is configured to perform the battery charging method described above.

An embodiment of this application provides a storage medium on which at least one computer instruction is stored. The computer instruction is loaded by a processor and used to perform the battery charging method described above.

The battery charging method according to the embodiments of this application effectively reduces the positive electrode voltage of the battery in a high temperature environment on the basis of ensuring consistency between the charge capacity of the battery charged under a high temperature and the charge capacity of the battery charged under a normal temperature, reduces a speed of reaction between a positive active material and the electrolytic solution under a high voltage in a corresponding system of the battery, and thereby improves the cycle performance and storage performance of the battery.

### BRIEF DESCRIPTION OF DRAWINGS

FIG. 1 is a schematic diagram of an electric device according to an embodiment of this application; and

FIG. 2 is a flowchart of a battery charging method according to an embodiment of this application.

### REFERENCE NUMERALS

| | |
|---|---|
| Electric device | 100 |
| Memory | 11 |
| Processor | 12 |
| Battery | 13 |

This application is described in further detail below with reference to specific embodiments and the drawings.

### DETAILED DESCRIPTION

The following describes the technical solutions in the embodiments of this application clearly and thoroughly with reference to the drawings hereof. Evidently, the described embodiments are merely a part of but not all of the embodiments of this application.

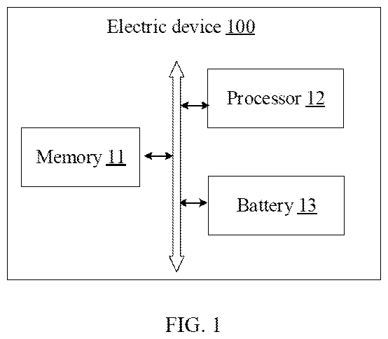

Referring to FIG. 1, FIG. 1 is a schematic diagram of an electric device according to an embodiment of this application. The electric device 100 contains, but without limitation, a memory 11, at least one processor I2, and a battery 13. Such components may be interconnected directly or by a bus.

It needs to be noted that FIG. 1 describes merely an example of the electric device 100. In other embodiments, the electric device 100 may include more or fewer components, or the configuration of the components may be different. The electric device 100 may be an electric motorcycle, an electric bicycle, an electric vehicle, a mobile phone, a tablet computer, a personal digital assistant, a personal computer, or any other rechargeable devices as appropriate.

In an embodiment, the battery 13 is a rechargeable battery configured to provide electrical energy to the electric device 100. For example, the battery 13 may be a lead-acid battery, a nickel-cadmium battery, a nickel-hydrogen battery, a lithium-ion battery, a lithium polymer battery, a lithium iron phosphate battery, or the like. The battery 13 is logically connected to the processor I2 through a battery management system (BMS), so that functions such as charging and discharging are implemented through the battery management system. The battery management system may be communicationally connected to a power conversion system (PCS) through controller area network (CAN) or RS485. The battery 13 includes a plurality of cells. The battery may be repeatedly charged in a rechargeable manner.

In this embodiment, understandably, the electric device 100 may further include other devices, such as a pressure sensor, a light sensor, a gyroscope, a hygrometer, an infrared sensor, and the like.

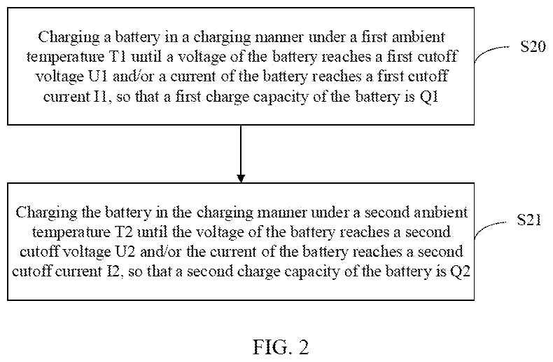

Refering to FIG. 2, FIG. 2 is a flowchart of a battery charging method according to an embodiment of this application. The battery charging method is applied to the battery. The battery charging method includes the following steps:

Step S20: Charging a battery in a charging manner under a first ambient temperature T1 until a voltage of the battery reaches a first cutoff voltage U1 and/or current of the battery reaches a first cutoff current I1, so that a first charge capacity of the battery is Q1.

In this embodiment of this application, when the battery is charged in different charging manners, the charge cutoff voltage is decreased and/or the charge cutoff current is increased in a high temperature environment, thereby keeping consistency between the charge capacity of the battery charged under a normal temperature and the charge capacity of the battery charged under a high temperature. It needs to be noted that the charging under a normal temperature is a charging process in which the ambient temperature of the battery is less than 35° C.; and the charging under a high temperature is a charging process in which the ambient temperature of the battery is greater than or equal to 35° C. and less than or equal to 60° C.

If the battery is charged in a charging manner under the first ambient temperature T1 until the voltage of the battery reaches the first cutoff voltage U1 and/or the current of the battery reaches the first cutoff current I1, the first charge capacity of the battery is calculated to be Q1, where T1<35° C. The first charge capacity is a full charge capacity of the battery under T1. It needs to be noted that the full charge capacity is a capacity of a battery system achieved when the voltage reaches the limited charge voltage and the current reaches the charge cutoff current by charging. The limited charge voltage and the charge cutoff current may be a fixed voltage and a fixed current, respectively, related to the battery system, or may be a voltage and current, respectively, set based on customer requirements.

It needs to be noted that the battery is controlled by a battery management system to reach the first cutoff voltage U1 and/or the first cutoff current I1 by charging.

It needs to be noted that, in this embodiment, the first cutoff voltage U1 is equal to the limited charge voltage U_{cl} of the battery or a system upper-limit voltage of the battery. In other embodiments, the first cutoff voltage U1 may be greater than the knifed charge voltage U_{cl} of the battery or the system upper-limit voltage of the battery, or may be less than the limited charge voltage ILI of the battery of the system upper-limit voltage of the battery. The value of the first cutoff voltage U1 is dependent on the charging manner. The charging manner includes a first charging manner and a second charging manner.

In this embodiment, the first charging manner includes N sequential charging sub-stages, where N is an integer greater than or equal to 2. The N charging sub-stages are defined as an charging sub-stage, where i=1, 2, 3, . . . , N, respectively. In the charging sub-stage, the battery is charged at an current or an voltage or an power. In an (i+1)^{th} Charging sub-stage, the battery is charged at an (i+1)^{th} current or an (i+1)^{th} voltage or an (i+1)^{th} power. A charge current of the battery in the (i+1)^{th} charging sub-stage is less than or equal to a charge current in the charging sub-stage.

In this embodiment, the (i+1)^{th} voltage is greater than or equal to the tri voltage, and the (i+1)^{th} power is less than or equal to the power.

In this embodiment, the second charging, manner includes M sequential charging sub-stages, where M is an integer greater than or equal to 2. The M charging sub-stages are defined as a j^{th} charging sub-stage, where j=1, M, respectively. Each j^{th} charging sub-stage includes a j^{th} earlier charging sub-stage and a j′h later charging sub-stage. In one of the j^{th} earlier charging sub-stage or the j^{th} later charging sub-stage, the battery is not charged or is charged or discharged at a j^{th} earlier charge sub-current for a duration of Tj1. In the other of the j^{th} earlier charging sub-stage or the j^{th} later charging sub-stage, the battery is charged at a j^{th} later charge sub-current for a duration of Tj2. An absolute value of the j^{th} earlier charge sub-current is smaller than an absolute value of the j^{th} later charge sub-current.

In this embodiment, an average value of a charge current in the (j+1)^{th} charging sub-stage is less than or equal to a charge current in the j^{th} sub-stage.

Step S21: Charging the battery in the charging manner under a second ambient temperature T2 until the voltage of the battery reaches a second cutoff voltage U2 and/or the current of the battery reaches a second cutoff current I2, so that a second charge capacity of the battery is Q2, where T2>T1, U2<U1, I1<I2, and Q1=Q2.

In this embodiment, the second ambient temperature T2 is greater than the first ambient temperature T1. In order to ensure that fine first charge capacity Q1 of the battery under the first ambient temperature is equal to the second charge capacity Q2 of the battery under the second ambient temperature, one of the following three conditions needs to be satisfied: (i) when the battery is charged in the charging manner under the second ambient temperature until the voltage reaches the second cutoff voltage U2, the second cutoff voltage U2 is less than the first cutoff voltage U1; (ii) when the battery is charged in the charging manner until the current reaches the second cutoff current I2, the second cutoff current I2 is less than the first cutoff current I1: and (iii) when the battery is charged in the charging manner until the voltage reaches the second cutoff voltage U2, and the current reaches the second cutoff current I2, the second cutoff voltage U2 is less than the first cutoff voltage U1 and the second cutoff current I2 is less than the first cutoff current I1.

In an embodiment, U2 is greater than or equal to a reduction potential of an electrolytic solution of the battery. In another embodiment. U_{cl}−500<U2<U_{cl}.

In some embodiments, I1<I2≤I1+0.2 C. In some other embodiments, I1+0.05 C≤I2≤I1+0.15 C. Understandably; C is a charge rate, that is, a measure of charging speed, and means a current value required for charging the battery to a rated capacity within a specified time. To be specific, charge or discharge rate=charge current/rated capacity of the battery.

In an embodiment, if the first charging manner is adopted, the second cutoff current I2 is less than or equal to the current of the battery at the time of completing the i^{st} charging sub-stage, or, if the second charging manner is adopted, the second cutoff current I2 is less than or equal to the current of the battery at the time of completing the i^{st} charging sub-stage.

An embodiment of this application discloses a charging method. By adopting the charging method according to this embodiment of this application, the battery can achieve the same charge capacity between a case of charging under a high temperature and a case of charging under a normal temperature, thereby effectively reducing the charge cutoff voltage and the positive electrode potential and increasing the high-temperature cycle life of the cells. The charging method is applicable to all lithium-ion batteries.

To make the objectives, technical solutions, and advantages of this application clearer, the following describes the battery charging method according to the present application in more detail with reference to drawings and embodiments. Understandably, the specific embodiments described herein are merely intended to explain this application, but not intended to limit this application.

The battery system adopted in the comparative embodiments and the embodiments uses lithium cobalt oxide as a positive electrode, and uses graphite as a negative electrode. The battery system further includes a separator, an electrolytic solution, and a packaging shell. The battery system is prepared though processes such as mixing, coating, assembling, chemical formation, and aging. For some cells in a winding process, a reference electrode is added between the positive electrode and the negative electrode to make a three-electrode battery, which is configured to test the difference between the positive electrode potential and the negative electrode potential of the battery during the charging.

The positive electrode of the battery is compounded of 96.7 wt % cobalt oxide LiCoO₂ as a positive active material, 1.7 wt % polyvinylidene difluoride (PVDF) as a binder, and 1.6 wt % conductive carbon black (SP) as a conductive agent. The negative electrode of the batten; is compounded of 98 wt′ artificial graphite as a negative active material, 1.0 wt % styrene butadiene rubber (SBR); emulsion as a binder, and 1.0 wt % sodium carboxymethyl cellulose (Carboxy Methyl cellulose, CMG) as a thickener. The separator is a highly adhesive composite film.

The limited charge voltage U_{c1} of the battery according to each comparative embodiment and each embodiment of this application is 4.45 V. It is hereby pointed out that the charging method according to this application is applicable to batteries of various voltage systems, and is not limited to the 4.45 V system. The charging method in the prior art (charging at a constant current and a constant voltage) adopted in the comparative embodiment is compared with the charging method adopted in the embodiments of this application to compare the percentage of decrease in the positive electrode potential, the percentage of thickness expansion of the cell, and the capacity retention rate at the end of 500 cycles.

A method for calculating the percentage of decrease in the positive electrode potential includes: charging the battery at a constant current of 0.7 C under an ambient temperature of 35° C. or 60° C. until the voltage reaches 4.45 V, and then charging the battery at a constant voltage until the current reaches 0.05 C. Recording a maximum value of the positive electrode potential of the battery as a reference potential. Then testing the maximum value of the positive electrode potential by adopting different charging methods and ambient temperatures in both the comparative embodiment and the embodiment. Calculating an absolute value of a difference between the maximum value of the positive electrode potential obtained in the comparative embodiment and the maximum value of the positive electrode potential obtained in the embodiment, and dividing the absolute value by the reference potential to obtain the percentage of decrease in the positive electrode potential.

A method for calculating the capacity retention rate includes: performing 500 charge and discharge cycles on the battery by repeating a corresponding charging process under an ambient temperature of 35° C. or 60° C., in both the comparative embodiment and the embodiment, and dividing a discharge capacity of the battery at the end of the 500 charge and discharge cycles by a discharge capacity at the end of the 1^{st} cycle to obtain the capacity retention rate.

A method for calculating the thickness expansion percentage of a cell includes: charging the battery to a fall capacity in different charging manners under an ambient temperature of 35° C. or 60° C., in both the comparative embodiment and the embodiment, measuring the thickness of the battery cell, and using the thickness as an initial thickness value. Then leaving the battery to stay in a high/low temperature thermostat under an 85° C. ambient temperature for 8 hours. Measuring the cell thickness of the battery at the end of the 8 hours, and dividing the difference between the cell thickness at the end of 8 hours and the initial thickness value by the initial thickness value to obtain the thickness expansion percentage of the cell. It needs to be noted that the lower the cell expansion rate, the better.

The existing charging manner in the Comparative Embodiment 1 is the constant-current and constant-voltage charging method in the prior art. A specific charging process of the existing charging manner under an ambient temperature of 35° C. and 60° C. respectively is described below. In the following charging process, neither the charge cutoff voltage of the battery during constant-current charging nor the charge cutoff current during constant-voltage charging is reduced under a high temperature condition (such as 60° C.).

Step 1: Charging the battery at a constant current of 0.7 C until the voltage reaches 4.45 V;

Step 2: Charging the battery at a constant voltage of 4.45 V until the current reaches 0.05 C;

Step 3: Letting the battery stand for 5 minutes:

Step 4: Discharging the battery at a constant current of 0.5 C Until the voltage reaches 3.0 V;

Step 5: Letting the battery stand for 5 minutes;

Step 6: Repeating steps 1 to 5 to complete 500 cycles.

### Embodiment 1

A charging process under an ambient temperature of 35° C. is as follows:
Step 1: Charging the battery at a constant current of 0.7 C until the voltage reaches 4.43 V;
Step 2: Charging the battery at a constant voltage of 4.43 V until the current reaches 0.05 C;
Step 3: Letting the battery stand for 5 minutes;
Step 4: Discharging the battery at a constant current of 0.5 C until the voltage reaches 3.0 V;
Step 5: Letting the battery stand for 5 minutes;
Step 6: Repeating steps 1 to 5 to complete 500 cycles.

A charging process under an ambient temperature of 60° C. (the charge cutoff voltage of the battery during constant-current charging is reduced under a high temperature condition) is as follows:
Step 1: Charging the battery at a constant current of 0.7 C until the voltage reaches 4.41 V;
Step 2: Charging the battery at a constant voltage of 4.41 V until the current reaches 0.05 C;
Step 3: Letting the battery stand for 5 minutes;
Step 4: Discharging the battery at a constant current of 0.5 C until the voltage reaches >0.0 V;
Step 5: Letting the battery stand for 5 minutes;
Step 6: Repeating steps 1 to 5 to complete 500 cycles.

### Embodiment 2

A charging process under an ambient temperature of 35° C. is as follows:
Step 1: Charging the battery at a constant current of 0.7 C until the voltage reaches 4.45 V;
Step 2: Charging the battery at a constant voltage of 4.45 V until the current reaches 0.12 C;
Step 3: Letting the battery stand for 5 minutes;
Step 4: Discharging the battery at a constant current of 0.5 C until the voltage reaches 3.0 V;
Step 5: Letting the battery stand for 5 minutes;
Step 6: Repeating steps 1 to 5 to complete 500 cycles.

A charging process under an ambient temperature of 60° C. (the charge cutoff current of the battery during constant-voltage charging is reduced under a high temperature condition) is as follows:
Step 1: Charging the battery at a constant current of 0.7 C until the voltage reaches 4.45 V;
Step 2: Charging the battery at a constant voltage of 4.45 V until the current reaches 0.2 C;
Step 3: Letting the battery stand for 5 minutes;
Step 4: Discharging the battery at a constant current of 0.5 C until the voltage reaches 3.0 V;
Step 5: Letting the battery stand fore 5 minutes;
Step 6: Repeating steps 1 to 5 to complete 500 cycles.

### Embodiment 3

A charging process under an ambient temperature of 35° C. is as follows:
Step 1: Charging the battery at a constant current of 0.7 C until the voltage reaches 4.48 V;
Step 2: Charging the battery at a constant voltage of 4.48 V until the current reaches 0.11 C;
Step 3: Letting the battery stand for 5 minutes;
Step 4: Discharging the battery at a constant current of 0.5 C until the voltage reaches 3.0 V;
Step 5: Letting the battery stand for 5 minutes;
Step 6: Repeating steps 1 to 5 to complete 500 cycles.

A charging process under an ambient temperature of 60° C. (the charge cutoff voltage of the battery during constant-current charging is reduced under a high temperature condition) is as follows:
Step 1: Charging the battery at a constant current of 0.7 C until the voltage reaches 4.43 V;
Step 2: Charging the battery at a constant voltage of 4.43 V until the current reaches 0.11 C;
Step 3: Letting the battery stand for 5 minutes;
Step 4: Discharging the battery at a constant current of 0.5 C until the voltage reaches 3.0 V;
Step 5: Letting the battery stand for 5 minutes;
Step 6: Repeating steps 1 to 5 to complete 500 cycles.

### Embodiment 4

A charging process under an ambient temperature of 35° C. is as follows:
Step 1: Charging the battery at a constant current of 0.7 C until the voltage reaches 4.5 V;
Step 2: Charging the battery at a constant voltage of 4.5 V until the current reaches 0.23 C;
Step 3: Letting the battery stand for 5 minutes;
Step 4: Discharging the battery at a constant current of 0.5 C until the voltage reaches 3.0 V;
Step 5: Letting the battery stand for 5 minutes;
Step 6: Repeating steps 1 to 5 to complete 500 cycles.

A charging process under an ambient temperature of 60° C. (the charge cutoff current of the battery during constant-voltage charging is increased under a high temperature condition) is as follows:
Step 1: Charging the battery at a constant current of 0.7 C until the voltage reaches 4.5 V
Step 2: Charging the battery at a constant voltage of 4.5 V until the current reaches 0.35 C;
Step 3: Letting the battery stand for 5 minutes;
Step 4: Discharging the battery at a constant current of 0.5 C until the voltage reaches 3.0 V;
Step 5: Letting the battery stand for 5 minutes;
Step 6: Repeating steps 1 to 5 to complete 500 cycles.

### Embodiment 5

A charging process under an ambient temperature of 35° C. is as follows:
Step 1: Charging the battery at a constant current of 0.7 C until the voltage reaches 4.4 V;
Step 2: Charging the battery at a constant voltage of 4.35 V until ti e current reaches 0.4 C;
Step 3: Charging the battery at a constant voltage of 4.43 V until the current reaches 0.05 C;
Step 4: Letting the battery stand for 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

A charging process under an ambient temperature of 60° C. (the charge cutoff voltage of the battery during constant-voltage charging is reduced under a high temperature condition) is as follows:
Step 1: Charging the battery at a constant current of 0.7 C until the voltage reaches 4.4 V;
Step 2: Charging the battery at a constant voltage of 4.35 V until the current reaches 0.4 C;
Step 3: Charging the battery at a constant voltage of 4.41 V until the current reaches 0.05 C;
Step 4: Letting the battery stand for 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

### Embodiment 6

A charging process under an ambient temperature of 35° C. is as follows:
Step 1: Charging the battery at a constant current of 0.7 C until the voltage reaches 4.4 V;
Step 2: Charging the battery at a constant voltage of 4.35 V until the current reaches 0.4 C;
Step 3: Charging the battery at a constant voltage of 4.43 V until the current reaches 0.012
Step 4: Letting the battery stand fore 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 300 cycles.

A charging process under an ambient temperature of 60° C. (the charge cutoff current of the battery during constant-voltage charging is increased under a high temperature condition) is as follows:
Step 1: Charging the battery at a constant current of 0.7 C until the voltage reaches 4.4 V;
Step 2: Charging the battery at a constant voltage of 4.35 V until the current reaches 0.4 C;
Step 3: Charging the battery at a constant voltage of 4.41 V until the current reaches 0.23 C;
Step 4: Letting the battery stand for 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

### Embodiment 7

A charging process under an ambient temperature of 35° C. is as follows:
Step 1: Charging the battery at a constant current of 0.7 C until the voltage reaches 4.4 V;
Step 2: Charging the battery at a constant power of 7.0 W until the voltage reaches 4.43 V;
Step 3: Charging the battery at a constant power of 5.5 W until the current reaches 0.05 C;
Step 4: Letting the battery stand for 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

A charging process under an ambient temperature of 60° C. (the charge cutoff voltage of the battery during constant-power charging is reduced under a high temperature condition) is as follows:
Step 1: Charging the battery at a constant current of 0.7 C until the voltage reaches 4.4 V;
Step 2: Charging the battery at a constant power of 7.0 W until the voltage reaches 4.41 V;
Step 3: Charging the battery at a constant power of 5.5 W until the current reaches 0.05 C;
Step 4: Letting the battery stand for 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

### Embodiment 8

A charging process under an ambient temperature of 35 is as follows:
Step 1: Charging the battery at a constant current of 0.7 C until the voltage reaches 4:4 V;
Step 2: Charging the battery at a constant power of 7.0 W until the voltage reaches 4.45 V;
Step 3: Charging the battery at a constant power of 5.5 W until the current reaches 0.12 C;
Step 4: Letting the battery stand for 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

A charging process under an ambient temperature of 60° C. (the charge cutoff current of the battery during constant-power charging is increased under a high temperature condition) is as follows:
Step 1: Charging the battery at a constant current of 0.7 C until the voltage reaches 4.4 V
Step 2: Charging the battery at a constant power of 7.0 W until the voltage reaches 4.45 V;
Step 3: Charging the battery at a constant power of 5.5 W until the current reaches 0.23 C;
Step 4: Letting the battery stand for 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

### Embodiment 9

A charging process under an ambient temperature of 35° C. is as follows:
Step 1: Charging the battery at a constant current of 0.7 C until the voltage reaches 4.4 V;
Step 2: Charging the battery at a constant power of 7.0 W until the voltage reaches 4.43 V;
Step 3: Charging the battery at a constant voltage of 4.43 V until the current reaches 0.05 C;
Step 4: Letting the battery stand for 5 minutes;
Step 5: Discharging the battery at a constant current of 0.5 C until the voltage reaches 3.0 V;
Step 6: Letting the battery stand fore 5 minutes;
Step 7: Repeating steps 1 to 6 to complete 500 cycles.

A charging process under an ambient temperature of 60 C. (the charge cutoff voltage of the battery during constant-power charging is reduced under a high temperature condition) is as follows:
Step 1: Charging the battery at a constant current of 0.7 C until the voltage reaches 4.4 V;
Step 2: Charging the battery at a constant power of 7.0 W until the voltage reaches 4.41 V;
Step 3: Charging the battery at a constant voltage of 4.41 V until the current reaches 0.05 C;
Step 4: Letting the battery stand for 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

### Embodiment 10

A charging process under an ambient temperature of 35° C. is as follows:
Step 1: Charging the battery at a constant current of 0.7 C until the voltage reaches 4.4 V;
Step 2: Charging the battery at a constant power of 7.0 W until the voltage reaches 4.45 V;
Step 3: Charging the battery at a constant voltage of 4.45 V until the current reaches 0.12 C;
Step 4: Letting the battery stand fore 0.5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

A charging process under an ambient temperature of 60° C. (the charge cutoff current of the battery during constant-voltage charging is increased under a high temperature condition) is as follows:
Step 1: Charging the battery at a constant current of 0.7 C until the voltage reaches 4.4 V;
Step 2: Charging the battery at a constant power of 7.0 W until the voltage reaches 4.45 V;
Step 3: Charging the battery at a constant voltage of 4.45 V until the current reaches 0.23 C;
Step 4: Letting the battery stand for 5 minutes;
Step 5: Discharging the battery at a constant current of 0.5 C until the voltage reaches 3.0 V;
Step 6: Letting the battery stand for 5 minutes;
Step 7: Repeating steps 1 to 6 to complete 500 cycles.

The percentage of decrease in the positive electrode potential, the capacity retention rate, and the percentage of thickness expansion of the cell are tested for the batteries in Embodiments 1 to 10 and Comparative Embodiment 1, and the test results are recorded in Table 1 below.

TABLE 1
Percentage of decrease in the positive electrode potential and the capacity retention rate of the battery under
different ambient temperatures, and the percentage of thickness expansion of the cell under 85° C.

| | | | | | Percentage | Capacity | | Percentage | Capacity | Percentage of |
|---|---|---|---|---|---|---|---|---|---|---|
| | | | | | of decrease | retention | | of decrease | retention | thickness |
| | | | | | in positive | rate alter | | in positive | rate | expansion of cell |
| | | | Charge | Charge | electrode | 500 | Charge | electrode | after 500 | stored ander |
| | | | capacity | capacity | potential | cycles | capacity | potential | cycles | 85° C. high |
| | | | under | under | under | under | under | under | under | temperature |
| Embodiment | Charging manner | | 25° C. | 35° C. | 35° C. | 35° C. | 60° C. | 60° C. | 60° C. | for 8 hours |
| Comparative | Existing | Reducing | 100% | 102% | Base (0%) | 75% | 105% | Base (0%) | 53% | 32% |
| Embodiment | charging | neither limited | | | | | | | | |
| 1 | manner | charge voltage | | | | | | | | |
| | | of cell nor | | | | | | | | |
| | | charge cutoff | | | | | | | | |
| | | current during | | | | | | | | |
| | | constant-voltage | | | | | | | | |
| | | charging under | | | | | | | | |
| | | a high | | | | | | | | |
| | | temperature | | | | | | | | |
| | | condition | | | | | | | | |
| Embodiment | Charging | Reducing | 100% | 100% | 1% | 84% | 100% | 2% | 72% | 19% |
| 1 | method | limited charge | | | | | | | | |
| | disclosed | voltage of cell | | | | | | | | |
| | herein | under a high | | | | | | | | |
| | | temperature | | | | | | | | |
| | | condition | | | | | | | | |
| Embodiment | Charging | Increasing | 100% | 100% | 1% | 86% | 100% | 2% | 68% | 22% |
| 2 | method | charge cutoff | | | | | | | | |
| | disclosed | current during | | | | | | | | |
| | herein | constant-voltage | | | | | | | | |
| | | charging under | | | | | | | | |
| | | a high | | | | | | | | |
| | | temperature | | | | | | | | |
| | | condition | | | | | | | | |
| Embodiment | Charging | Reducing | 100% | 100% | 1% | 87% | 100% | 2% | 69% | 18% |
| 3 | method | limited charge | | | | | | | | |
| | disclosed | voltage of cell | | | | | | | | |
| | herein | under a high | | | | | | | | |
| | | temperature | | | | | | | | |
| | | condition | | | | | | | | |
| Embodiment | Charging | Increasing | 100% | 100% | 1% | 83% | 100% | 2% | 70% | 22% |
| 4 | method | charge cutoff | | | | | | | | |
| | disclosed | current during | | | | | | | | |
| | herein | constant-voltage | | | | | | | | |
| | | charging under | | | | | | | | |
| | | a high | | | | | | | | |
| | | temperature | | | | | | | | |
| | | condition | | | | | | | | |
| Embodiment | Charging | Reducing | 100% | 100% | 1% | 82% | 100% | 2% | 70% | 22% |
| 5 | method | limited charge | | | | | | | | |
| | disclosed | voltage of cell | | | | | | | | |
| | herein | under a high | | | | | | | | |
| | | temperature | | | | | | | | |
| | | condition | | | | | | | | |
| Embodiment | Charging | Increasing | 100% | 100% | 1% | 86% | 100% | 2% | 71% | 21% |
| 6 | method | charge cutoff | | | | | | | | |
| | disclosed | current during | | | | | | | | |
| | herein | constant-voltage | | | | | | | | |
| | | charging under | | | | | | | | |
| | | a high | | | | | | | | |
| | | temperature | | | | | | | | |
| | | condition | | | | | | | | |
| Embodiment | Constant- | Reducing charge | 100% | 100% | 1% | 82% | 100% | 2% | 72% | 24% |
| 7 | power | cutoff voltage of | | | | | | | | |
| | charging | cell under a high | | | | | | | | |
| | manner | temperature | | | | | | | | |
| | | condition | | | | | | | | |
| Embodiment | Charging | Increasing | 100% | 100% | 1% | 82% | 100% | 2% | 74% | 23% |
| 8 | method | charge cutoff | | | | | | | | |
| | disclosed | current during | | | | | | | | |
| | herein | constant-power | | | | | | | | |
| | | charging under | | | | | | | | |
| | | a high | | | | | | | | |
| | | temperature | | | | | | | | |
| | | condition | | | | | | | | |
| Embodiment | Charging | Reducing charge | 100% | 100% | 1% | 85% | 100% | 2% | 71% | 23% |
| 9 | method | cutoff voltage of | | | | | | | | |
| | disclosed | cell under a high | | | | | | | | |
| | herein | temperature | | | | | | | | |
| | | condition | | | | | | | | |
| Embodiment | Charging | Increasing | 100% | 100% | 1% | 84% | 100% | 20% | 69% | 19% |
| 10 | method | charge cutoff | | | | | | | | |
| | disclosed | current during | | | | | | | | |
| | herein | constant-voltage | | | | | | | | |
| | | charging under | | | | | | | | |
| | | a high | | | | | | | | |
| | | temperature | | | | | | | | |
| | | condition | | | | | | | | |

As can be seen from Comparative Embodiment 1 and Embodiments 1 to 10 in Table 1, by reducing the charge cutoff voltage and/or increasing the charge cutoff current of the battery under a high temperature envitoninent, the charging method according to the embodiments of this application ensures consistency between the charge capacity of the battery under a high temperature and the charge capacity under a normal temperature, thereby effectively improving the capacity retention rate of the battery after cyclic charging. The capacity retention rate of the battery in 35° C. and 60° C. environments in Embodiments 1 to 10 of this application is higher than that in Comparative Example 1. The capacity retention rate in a 35° C. environment is increased by approximately 9% on average, and the capacity retention rate in a 60° C. environment is increased by approximately 18% on average. The percentage of thickness expansion of the cell is also reduced. The percentage of thickness expansion of the cell in an 85° C. environment in Embodiments 1 to 10 is lower than that in Comparative Embodiment 1, and is reduced by approximately 11% on average. That is mainly because the charging method according to the embodiments of this application effectively reduces the positive electrode voltage of the battery in a high temperature environment on the basis of ensuring consistency of capacity, reduces the speed of reaction between the positive active material and the electrolytic solution under a high voltage in a corresponding system of the battery, and thereby improves the cycle performance and storage performance of the battery.

Still referring to FIG. 1, in this embodiment, the memory 11 may be an internal memory of the electric device 100, that is, a memory built in the electric device 100. In other embodiments, the memory 11 may be an external memory of the electric device 100, that is, a memory externally connected to the electric device 100.

In some embodiments, the memory 11 is configured to store program code and various data, and access the programs and data automatically at a high speed during operation of the electric device 100.

The memory 11 may include a random access memory, and may thither include a non-volatile memory, such as a hard disk, an internal memory, a plug-in hard disk, a smart media card (SMC), a secure digital (SD) card, a flash card at least one disk storage device, a flash memory device, or other volatile solid-state storage devices.

In an embodiment, the processor I2 may be a central processing unit (CPU), or may be another general-purpose processor, a digital signal processor (DSP), an application-specific integrated circuit (ASIC), a field programmable gate array (FPGA), or another programmable logical device, a discrete gate or a transistor logical device, a discrete hardware component, or the like. The general-purpose processor may be a microprocessor, or the processor may be any other conventional processor or the like.

The program code and various data in the memory 11, when implemented in the form of a software functional unit and sold or used as an independent product, may be stored in a computer-readable storage medium. Based on such an understanding, all or part of the processes of the method described in the foregoing embodiments, for example, the steps of the battery voltage difference update method or the charge estimation method according to this application, may be performed by relevant hardware instructed by a computer program. The computer program may be stored in a computer-readable storage medium. When executed by a processor, the computer program can perform the steps in each method embodiment described above. The computer program includes computer program code. The computer program code may be in the form of source code, object code, an executable file, or some intermediate forms, or the like. The computer-readable medium may include any entity or device capable of carrying the computer program code, record medium, USB disk, mobile hard disk, magnetic disk, optical disk, computer memory, read-only memory MOM), and the like.

Understandably, the division into the modules is a logical function division, and may be in other division forms in actual implementation. In addition, function modules in each embodiment of this application may be integrated into one processing unit, or each module may exist physically alone, or two or more modules may be integrated into one unit. The integrated module may be implemented in the form of hardware, or may be implemented in the form of hardware plus a software function module.

Finally, it needs to be noted that the foregoing embodiments are merely intended for describing the technical solutions of this application but not intended as a limitation. Although this application is described in detail with reference to the foregoing optional embodiments, a person of ordinary, skill in the art understands that modifications or equivalent substitutions may be made to the technical solutions of this application without departing from the spirit and scope of the technical solutions of this application.

What is claimed is:

1. A method for charging a battery, the method comprising:
charging the battery under a first ambient temperature T1 until a voltage of the battery reaches a fast cutoff voltage U1 and/or a current of the battery reaches a first cutoff current 11, so that a first charge capacity of the battery is Q1; and
charging the battery under a second ambient temperature T2 until the voltage of the battery reaches a second cutoff voltage U2 and/or the current of the battery reaches a second cutoff current I2, so that a second charge capacity of the battery is Q2, Wherein
T2>T1, U2<U1, I1<I2, and Q1=Q2.

2. The charging method according to claim 1, wherein T1<35° C., and 35° C.<T2≤60° C.

3. The charging method according to claim 1, wherein the second cutoff voltage U2 is greater than or equal to a reduction potential of an electrolytic solution of the battery.

4. The charging method according to claim 3, wherein U_{cl}−500 mV≤U2<U_{cl}, wherein U_{c1} is a limited charge voltage of the battery.

5. The charging method according to claim 1, wherein 1.1<I2≤I1+0.2 C.

6. The charging method according to claim 1, Wherein the first charge capacity is a full charge capacity of the battery under T1.

7. The charging method according to claim 1, wherein the charging the battery comprises N sequential charging sub stages N is an integer greater than or equal to 2, and the N charging sub-stages are defined a qui i^{th} charging sub-stage, wherein i=1, 2, N, respectively; in the charging sub-stage, the battery is charged at an i^{th} current or an i^{th} voltage or an i^{th} power; and, in an (i+1)^{th} charging sub-stage, the battery is charged at an (i+1)^{th} current or an (i+1)^{th} voltage or an (i+1)^{th} power, wherein a charge current of the battery in the (i+0.1)^{th} charging sub-stage is less than or equal to a charge current in the i^{th} charging sub-stage.

8. The charging method according to claim 7, wherein the (i+1)^{th} voltage is greater than or equal to the ifs voltage, and the (1+1)^{th} power is less than or equal to the power.

9. The charging, method according to claim 1, wherein the charging the battery comprises M sequential charging sub-stages, M is an integer greater than or equal to 2, the M charging sub-stages are defined as a j^{th} charging sub-stage, wherein j=1, 2, . . . , M, respectively, and each j^{th} charging sub-stage comprises a j^{th} earlier charging sub-stage and a j^{th} later charging stub-stage; in one of the j^{th} earlier charging sub-stage or the j^{th} later charging sub-stage, the battery is not charged or is charged or discharged at a j^{th} earlier charge sub-current for a duration of Tj1; and, in the other of the j^{th} earlier charging sub-stage or the j^{th} later charging sub-stage, the battery is charged at a j^{th} later charge sub-current for a duration of Tj2, wherein an absolute value of the j^{th} earlier charge sub-current is smaller than an absolute value of the j^{th} later charge sub-current.

10. The charging method according to claim 9, wherein an average value of a charge current in the 0+1)^{th} charging sub-stage is less than or equal to a charge current in the j^{th} sub-stage.

11. An electric device, comprising:
a battery; and
a processor, configured to charge the battery by performing a charging method, wherein the charging method, comprises;
charging the battery under a first ambient temperature T1 until a voltage of the battery reaches a first cutoff voltage U1 and/or a current of the battery reaches a first cutoff current I1, so that a first charge capacity of the battery is and
charging the battery under a second ambient temperature T2 until the voltage of the battery reaches a second cutoff voltage U2 and/or the current of the battery reaches a second cutoff current I2, so that a second charge capacity of the battery is Q2, wherein T2>T1, U2<U1, I1<I2, and Q1=Q2.

12. The electric device according to claim 11, wherein T1<35° C., and 35° C.≤T2<60° C.

13. The electric device according to claim 11, wherein the second cutoff voltage U2 is greater than or equal to a reduction potential of an electrolytic solution of the battery.

14. The electric device according to claim 13, wherein U_{cl}−500 mV<11<U_{cl}, wherein Ltd is a limited charge voltage of the battery.

15. The electric device according to claim 11, wherein I1<I2≤I1+0.2 C.

16. The electric device according to claim 11, wherein the first charge capacity is a charge capacity of the battery under T1.

17. The electric device according to claim 11, wherein the charging the battery comprises N sequential charging sub-stages, N is an integer greater than or equal to 2, and the N charging sub-stages are defined an i^{th} charging sub-stage, wherein i=1, 2, N, respectively; in the charging sub-stage, the battery is charged at an current or tan i^{th} voltage or an i^{th} power; and, in an (i+1)^{th} charging sub-stage, the battery is charged at an (i+1)^{th} current or an (i+1)^{th} voltage or an (i+1)^{th} power, wherein a charge current of the battery in the (i+1)^{th} charging sub-stage is less than or equal to a charge current in the i^{th} charging sub-stage.

18. The electric device according to claim 17, wherein the (i+1)^{th} voltage is greater than or equal to the i^{th} voltage, and the (i+1)^{th} power is less than or equal to the power.

19. The electric device according to claim 11, wherein the charging the battery comprises M sequential charging sub-stages, M is an integer greater than or equal to 2, the M charging sub-stages are defined as a charging, sub-stage, wherein j=1, 2, . . . , M, respectively, and each j^{th} charging sub-stage comprises a j^{th} earlier charging sub-stage and alt later charging sub-stage, in one of the j^{th} earlier charging sub-stage or the j^{th} later charging sub-stage, the battery is not charged or is charged or discharged at a j^{th} earlier charge sub-current for a duration of Tj1; and, in the other of the j^{th} earlier charging sub-stage or the j^{th} later charging sub-stage, the battery is charged at a j^{th} later charge sub-current for a duration of Tj2, wherein an absolute value of the j^{th} earlier charge sub-current is smaller than an absolute value of the j^{th} later charge sub-current.

20. A storage medium, storing at least one computer instruction, wherein the instruction is loaded by a processor and used to perform a charging method, wherein the charging method, comprises:
charging a battery under a first ambient temperature T1 until a voltage of the battery reaches a first cutoff voltage U1 and/or a current of the battery reaches a first cutoff current I1, so that a first charge capacity of the battery is Q1; and
charging the battery under a second ambient temperature T2 until the voltage of the battery reaches a second cutoff voltage U2 and/or the current of the battery reaches a second cutoff current I2, so that a second charge capacity of the battery is Q2, wherein
T2>T1, U2<U1 I1<I2, and Q1=Q2.
